(19) United States
(12) Patent Application Publication
(10) Pub. No.: US 2023/0323246 A1
(43) Pub. Date: Oct. 12, 2023

(54) SYSTEMS, METHODS, AND APPARATUSES FOR IMPLEMENTING CEREBRUM MATTER-POWERED LIGHT EMISSIONS IN THE CONTEXT OF A POST-MORTEM RITUAL

(71) Applicant: Andrew Alton Larsen, Happy Valley, OR (US)

(72) Inventor: Andrew Alton Larsen, Happy Valley, OR (US)

(21) Appl. No.: 18/098,629

(22) Filed: Jan. 18, 2023

Related U.S. Application Data
(60) Provisional application No. 63/328,136, filed on Apr. 6, 2022.

(51) Int. Cl. C11C 5/00; H02N 3/00; F21V 7/06; C10L 8/00

(52) U.S. Cl. CPC C11C 5/002; C10L 8/00; F21V 7/06; H02N 3/00

(57) ABSTRACT

Systems, methods, and apparatuses for implementing cerebrum matter-powered light emissions in the context of a post-mortem ritual are described herein. For example, according to one embodiment there is a method for transforming cerebrum matter into projected light energy, including: obtaining brain matter from a deceased human body; processing the brain matter to generate a fuel-based extract by boiling the brain matter in a vessel to extract fat from the brain matter; burning the fuel-based extract to produce heat energy; capturing heat energy from burning the fuel-based extract via a thermoelectric generator positioned between the fuel-based extract and a chamber containing water to generate a voltage buildup, in which the voltage buildup is based on a temperature gradient difference between a first face of the thermoelectric generator juxtaposed with the burning fuel-based extract and a second face of the thermoelectric generator juxtaposed with the chamber containing water; maintaining the voltage buildup via maintaining the temperature gradient difference by replenishing the water in the chamber; transferring, via a cable, the voltage buildup to power a light source connected to the thermoelectric generator; powering the light source to emit light energy based on the voltage buildup; projecting the emitted light energy along a space flight path; and continuing to power the light source until the fuel-based extract is depleted. Other related embodiments are disclosed.

### CLAIM OF PRIORITY

This non-provisional U.S. Utility patent application is related to, and claims priority to, the U.S. Provisional Patent Application No. 63/328,136, entitled “SYSTEMS, METHODS, AND APPARATUSES FOR IMPLEMENTING CEREBRUM MATTER-POWERED PHASE TRANSITIONS FOR ACHIEVING COSMIC LUMINESCENCE,” filed Apr. 6, 2022, having Attorney Docket No. 38120.606P, the entire contents of which are incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments disclosed herein relate generally to the field of post-mortem rituals and more particularly, disclosed embodiments relate to systems, methods, and apparatuses for implementing cerebrum matter-powered light emissions in the context of a post-mortem ritual, such as a funeral.

### BACKGROUND

The subject matter discussed in the background section is not to be considered prior art merely because of its mention in the background section. Similarly, a problem mentioned in the background section or associated with the subject matter of the background section shall not be considered to have been previously recognized in the prior art. The subject matter in the background section merely represents different approaches, which in and of themselves, may also correspond to claimed embodiments.

Post-mortem rituals (e.g., “funerals”) have been a part of humanity since ancient times. These include various procedures and ceremonies involving the deceased and their body such as funerals, cremation, and in some cultures, the removal of organs including the brain (excerebration). Famously, the Ancient Egyptians created elaborate tombs and mummified the bodies of deceased pharaohs, the wealthy, and animals by embalming the bodies and wrapping them in strips of linen to preserve the bodies. Food, personal effects, and other objects were also buried along with the deceased as part of the post-mortem rituals in such ancient cultures. These aforementioned practices served to honor the dead and were based on various beliefs regarding the afterlife and immortality.

Problematically, in the modern-day, many are unable to arrange non-traditional and sometimes elaborate post-mortem rituals which require the removal and preservation or conversion of their organs due to the cost and unavailability of such services. Furthermore, the loved ones of deceased individuals may desire to honor their dead in ways beyond traditional funeral and cremation services in a way that gives greater meaning and connection to the universe and humanity's place in it.

What is needed is a way to memorialize the deceased in a way that utilizes legitimate science-based techniques which convert and capture energy from the remains of loved ones into alternate forms of matter and energy, which can then be utilized to power light emissions, providing not only a technically feasible approach, but also a post-mortem ritual which is desired by those seeking to honor the passing of their loved ones.

The present state of the art may therefore benefit from the systems, methods, and apparatuses for implementing cerebrum matter-powered light emissions in the context of a post-mortem ritual.

### BRIEF DESCRIPTION OF THE DRAWINGS

Embodiments are illustrated by way of example, and not by way of limitation, and will be more fully understood with reference to the following detailed description when considered in connection with the figures in which:

FIG. 1 depicts an exemplary flow diagram illustrating obtaining brain matter for the Life Light method, in accordance with described embodiments;

FIG. 2A depicts an exemplary flow diagram illustrating the conversion of brain matter to a fuel-based extract, in accordance with described embodiments;

FIG. 2B depicts an exemplary flow diagram illustrating a boil and strain technique for converting brain matter to a fuel-based extract, in accordance with described embodiments;

FIG. 3 depicts an exemplary system for converting burned fuel-based extract material to electrical energy and connection to a power source, in accordance with described embodiments;

FIG. 4 depicts an exemplary use of a lit fuel-based extract with a parabolic mirror to emit light energy, in accordance with described embodiments;

FIG. 5 depicts an exemplary diagram illustrating the projection of emitted light from a light source harnessed with the energy of burning fuel-based extract into the cosmos, in accordance with described embodiments;

FIG. 6 depicts a flow diagram illustrating a method for implementing cerebrum matter-powered phase transitions for achieving cosmic luminescence, in accordance with disclosed embodiments;

FIG. 7 shows a diagrammatic representation of a system within which embodiments may operate, be installed, integrated, or configured, in accordance with one embodiment; and

FIG. 8 illustrates a diagrammatic representation of a machine in the exemplary form of a computer system, in accordance with one embodiment.

### DETAILED DESCRIPTION

Described herein are systems, methods, and apparatuses for implementing cerebrum matter-powered phase transitions for achieving cosmic luminescence.

For example, according to one embodiment there is a method for transforming cerebrum matter into projected light energy, including: obtaining brain matter from a deceased human body; processing the brain matter to generate a fuel-based extract by boiling the brain matter in a vessel to extract fat from the brain matter; burning the fuel-based extract to produce heat energy; capturing heat energy from burning the fuel-based extract via a thermoelectric generator positioned between the fuel-based extract and a chamber containing water to generate a voltage buildup, in which the voltage buildup is based on a temperature gradient difference between a first face of the thermoelectric generator juxtaposed with the burning fuel-based extract and a second face of the thermoelectric generator juxtaposed with the chamber containing water; maintaining the voltage buildup via maintaining the temperature gradient difference by replenishing the water in the chamber; transferring, via a cable, the voltage buildup to power a light source connected to the thermoelectric generator; powering the light source to emit light energy based on the voltage buildup; projecting the emitted light energy along a space flight path; and continuing to power the light source until the fuel-based extract is depleted.

In the following description, numerous specific details are set forth such as examples of specific configurations, use cases, materials, components, etc., in order to provide a thorough understanding of the various embodiments. It will be apparent, however, to one skilled in the art that these specific details need not be employed to practice the embodiments disclosed herein. In other instances, well-known materials or methods have not been described in detail in order to avoid unnecessarily obscuring the disclosed embodiments.

In addition to various hardware components depicted in the figures and described herein, embodiments further include various operations described below. The operations described in accordance with such embodiments may be performed by specially manufactured components or may utilize general-purpose components in certain instances to realize and perform the innovative function and configuration of the described embodiments. Alternatively, the operations may be performed by a combination of customized specially manufactured components with certain general-purpose components to make, use, and practice the inventive aspects as set forth herein.

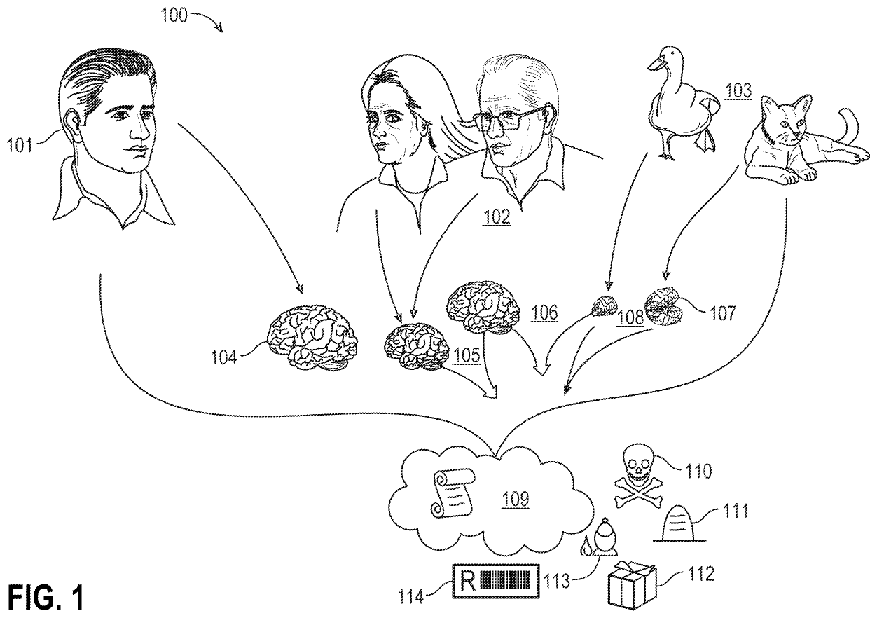

FIG. 1 depicts an exemplary flow diagram 100 illustrating obtaining brain matter for the Life Light method, in accordance with described embodiments.

As shown here, brain matter 104-107 of differing sources may be obtained from various deceased loved ones, including a person 101 or even a couple 102. Similarly depicted is the utilization of deceased pets 103 as the source, such as the brain matter 107 and 108 of a dog, cat, bird, etc., such as that which is depicted here.

According to certain embodiments, the brain matter selected and ultimately used for the Life Light method as described herein may be various combinations of brain matter 104-107 from one or more of individual persons, couples, and pets. The motivation for combinations of brain matter 104-107 may include, for example, the wishes of an individual or the solace and peace brought to family members or former pet owners to have brain matter of departed loved ones (humans and/or animals) combined and converted directly and indirectly into light energy representing the energy of departed loved ones sent in a unified manner into and across the universe.

According to certain embodiments, a registry 109 is used to register and coordinate delivery of brain matter from a deceased individual 101, couple 102, or pet animal 103 to family members and former pet owners, respectively. According to certain embodiments, a bar-code, QR code, or other similar tracking serial number 114 may be utilized to scan and then track the brain matter throughout the system, for instance, by linking the tracking serial number 114 with an item on the registry 109.

Such a registry 109 may further include the ability for a family member, pet owner, or one or more persons to register and specify specific parts or sub-sections of the donor brain matter, which is to be separated and obtained, if desired by the family or whomever the user is submitting such a request. Additionally, the register 109 permits users to specify and thus coordinate the retrieval of donor brain matter 104-107 from multiple humans or multiple animals or some combination of brain material donors which is to be collected and then combined.

According to certain embodiments, one or more persons may register and specify their desired configuration and operational parameters utilizing the registry 109 before their own death occurs. Or instance, a married couple may wish to utilize the service, and may therefore register with the service and specify their particular configuration and parameters with the service which are saved to the registry. Obviously, the donor brain matter cannot be collected until after death of the donor be it a human or animal, and therefore, the collection and the donor may be specified prior to death and even permit for the donor to be the user, with that person's wishes to then be facilitated post-mortem.

In certain embodiments, the Life Light service additionally facilitates the use of legal documents which are required to facilitate the carrying out of the donor brain matter subsequent to death. For instance, a last will and testament may need to be updated or amended or an “Advanced Directives” legal document may be utilized, depending upon the legal jurisdiction, to specify the wishes of the deceased prior to that person having died. The legal instrument, whether an advanced directive legal document or a last will and testament, will thus be structured so as to expressly specify the collection of the donor brain matter and to have the collection facilitated by or performed by the Life Light service, from which the energy is then converted or extracted in fulfillment of the light emission process which is described in greater detail below.

Additionally, through the use of the registry 109, the legal instrument is additionally uploaded and retained. This document may be made public upon death or may be made accessible to specified individuals or entities such as family members, doctors, hospitals, hospice, etc. By making the document available to appropriate parties and entities, the Life Light service can help to assure that the person having chosen to utilize the Life Light service while still living will in actuality have their final wishes carried out appropriately and in the manner specified by that person after their own death. To state this more directly, if a person chooses to utilize the Life Light services while living, then the utilization of the legal instruments and recording of those legal instruments within the registry 109 may help to facilitate the carrying out of that person's wishes. The reason this may be needed is because despite an individual choosing for themselves how their body is to be treated after death, it is possible that family members may attempt to intervene and express upon and seek to carry out their own wishes which may conflict with the final wishes of the deceased. The legal instrument makes express the wishes of the deceased and can thus facilitate ensuring that the wishes of the deceased are carried out, notwithstanding the objections by others.

It is acknowledged that the concept of extracting brain matter may seem dark, macabre, or even taboo. However, so long as the practice is not subject to legal prohibition (e.g., criminal or otherwise) in a particular jurisdiction, then it is of the opinion of the Life Light service provider that the wishes of the deceased loved one should be honored and carried out, even over the objection of family members.

In some legal jurisdictions, the legal instrument may be needed by the courts or funeral home, hospital, or other entity with control of the physical body before releasing either the donor brain matter of the deceased or the body of the deceased to the Life Light service or whoever is responsible for performing the extraction and processing of the brain matter.

The opposite situation may also occur insomuch that a deceased individual may not have left final instructions regarding their preference for funeral, cremation, burial, and any associated post-mortem rituals. In fact, this is quite common. In such situations, it is extremely common for the choice to be left to remaining loved ones to coordinate and then carry out their chosen post-mortem rituals for the deceased loved one, be it a human or a pet. Thus, individuals may therefore request the services of Life Light to extract the donor brain matter and facilitate the light emissions process.

As before, it may be that a particular legal instrument which makes express the wishes of the surviving family members may be needed to facilitate their wishes to utilize the Life Light service. In such situations, then again an “Advanced Directives” legal document, or merely a notarized letter or potentially even a court order may be acquired and then uploaded into the registry and made available to other parties and entities so as to ensure that the instructions are carried out, subject to any legal prohibitions in the relevant jurisdiction.

According to certain embodiments, the parts of the brain to be separated may include the whole or part of the various divisions of the brain including but not limited to the cerebrum and its various components (including the cortex/gray matter, amygdala, inner layer/white matter, and the prefrontal, frontal, parietal, temporal, and occipital lobes of the cortex), cerebellum, pons, medulla/brain stem, etc. The brain and its various parts and surrounding structures are herein referred to as “brain matter” or “donor brain matter” or “cerebrum matter.”

Registry 109 may be cloud-based and allows for coordination with other post-mortem services such as morgues 110, obituaries, cemeteries 111, pet cemeteries, crematoriums 113, etc. According to certain embodiments, delivery of the brain matter may be through mail 112 or other delivery means. According to certain embodiments, before delivery to the family member or former pet owner, the desired brain matter is converted into a fuel-based extract to be discussed further below.

According to certain embodiments, the brain matter or entire brain 104-107 is removed trans-nasally (via the nostrils) or via other routes involving drilling or fracturing bones of the cranium including the ethmoid and sphenoid bones. Surgical instruments such as forceps or an orbitoclast may be used.

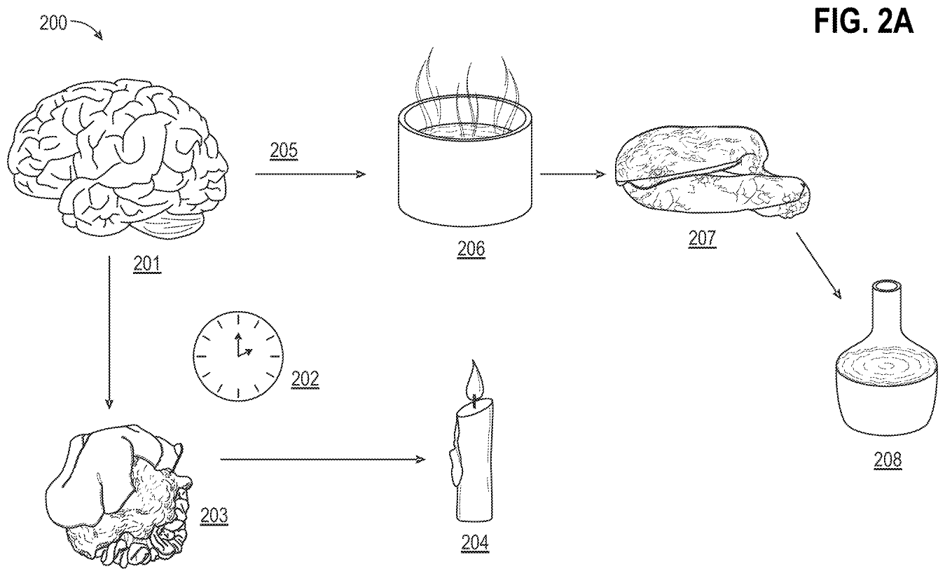

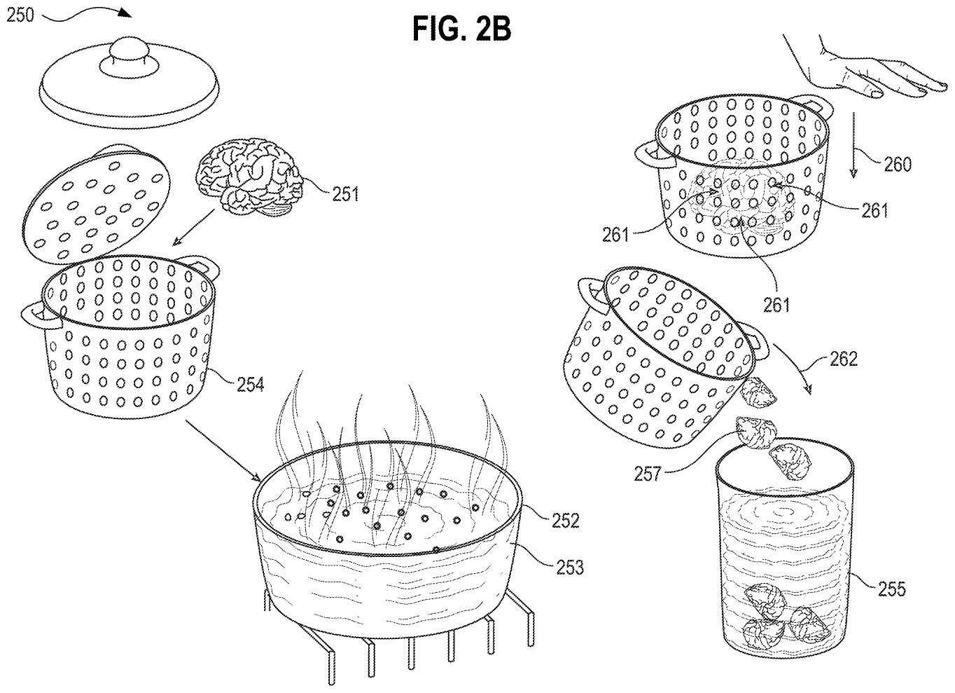

FIG. 2A depicts an exemplary flow diagram 200 illustrating the conversion of brain matter to a fuel-based extract 204 and 208, in accordance with described embodiments.

As shown here, brain matter 201 removed from a deceased person, a deceased couple, a deceased animal, or a combination thereof. Once removed, the brain matter 201 is boiled 206 or otherwise treated with chemicals or other processes to extract brain fatty matter 207.

According to certain embodiments, brain matter 201 may be cut or chopped into smaller pieces and boiled in open vats or cooked in steam digesters. Brain matter 201 may be further processed through heating at low temperature for a period of time 202 followed by straining the brain fatty matter 207 or other means such as water refining (treating with water and centrifuging), winterizing (dissolving in ethanol and freezing), or separation based on melting point to produce a fuel-based extract 208 which may be an oil or other substance.

According to yet other embodiments, natural generation of corpse wax (“adipocere”) 203 occurs as fat within the brain matter in the deceased human body decomposes through anaerobic bacterial hydrolysis that occurs over a few months following death. Once adipocere 203 is generated, it may be processed, segmented, and/or fashioned to produce a candle 204 which may be used as a fuel-based extract 208.

Other processes are permitted which result in the extraction and conversion of the base extract 208 from the donor brain matter 201, such that it may be subsequently utilized to produce heat, light, or electrical energy configured and capable of powering a light emission from a light source.

FIG. 2B depicts an exemplary flow diagram 250 illustrating a boil and strain technique for converting brain matter to a fuel-based extract 208, in accordance with described embodiments.

As shown here, brain matter 251 may be placed inside strainer 254 and placed within a pot 252 containing water or other liquid 253. Strainer 254 may have various openings and once brain matter 251 is placed inside strainer 254, strainer 254 may be pressed down 260 to strain 261 fat, oil, and water from the brain matter 251. The donor brain matter 251 is placed inside strainer 254 before pressing 260 or one or more of the strained fat, oil, and water from brain matter 251 and after pressing with strainer 254, the strained brain matter 251 may then be slow-boiled inside pot 252 containing water or other liquid 253 for a period of time such as ten hours or longer. Next, the resulting residue 257 from the donor brain matter 251 having been previously strained and then boiled, may then be collected or poured 262 into vessel 255 and thus, provide a substance which is ready to serve as a fuel-based extract 208.

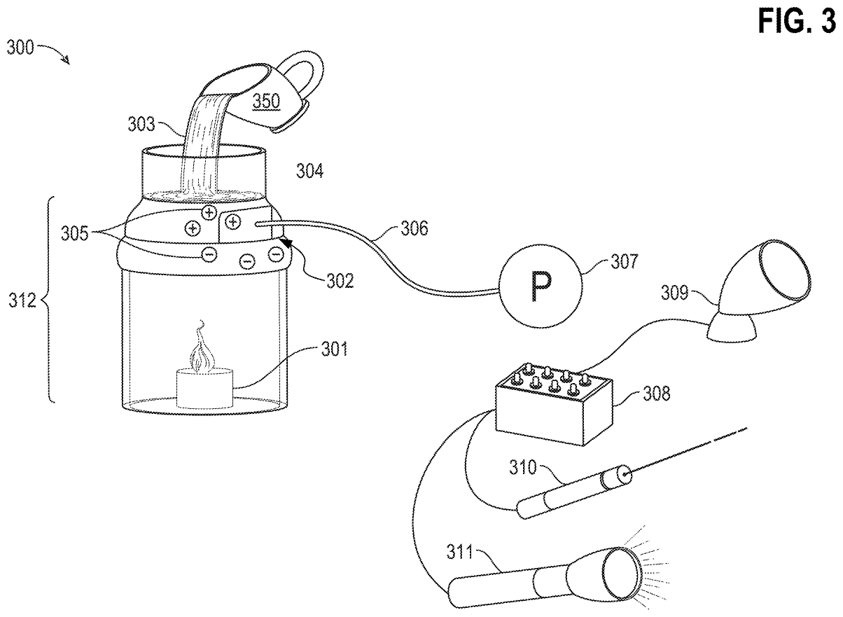

FIG. 3 depicts an exemplary system 300 for converting burned fuel-based extract material to electrical energy and connection to a power source, in accordance with described embodiments.

As shown here, fuel-based extract 301, such as a candle or liquid fuel, is placed at the base of apparatus 312 and lit or otherwise ignited so as to release heat energy. Water chamber 304 is filled with water 303 or other liquid from vessel 350. According to certain embodiments, the temperature of the water 303 or other liquid may vary. Apparatus 312, placed between fuel-based extract 301 and water chamber 304, contains a thermoelectric generator 302 which converts heat energy to electrical energy resulting in electrical potential with a given voltage.

As heat energy is released from the burning fuel-based extract 301 or from the flame ignited upon a wick inserted into a wax of the burning fuel-based extract 301, the temperature difference between the heat energy and the water 303 or other liquid in the water chamber 304 causes a charge buildup on the thermoelectric generator 302 resulting in a voltage 305. According to certain embodiments, this temperature difference may manifest as a temperature difference between a first face of thermoelectric generator 302 facing burning fuel-based extract 301 and a second face of thermoelectric generator 302 facing water chamber 304.

Voltage 305 is channeled as electrical energy to power source 307 via which to power a light emission or alternatively may be transmitted to the light source via a cable 306 or other connector. Similarly, the voltage may be transmitted to a battery 308 for storage and subsequent utilization to power a light emission.

According to certain embodiments, power source 307 may be a battery 308 connected to a light source 309. According to other embodiments, power source 307 may be a battery, cell, or other power unit within a light source. Light sources may include artificial light sources that emit concentrated light such as a laser 310, flashlight 311, spot beam or spotlight, as well as light sources that emit diffuse light, which may include light sources having filters made of a material such as glass, Teflon, silk, etc. or sheets and films made of polycarbonate and acrylic.

For instance, a Light Emitting Diode or “LED” may be utilized as the light source via which to broadcast light emissions powered by the power source 307, be it directly powered or powered by saved energy from the battery 308. All of the light sources result in light emission, however, the light may take on different forms, such as laser light which travels farther, diffuse light which travels a shorter distance but lights a greater immediate area, candle light which is emitted directly from the wick inserted into a wax of the burning fuel-based extract 301 and upon which an open flame emits the light emissions, or variously configured LED light emissions which may be broad spectrum or narrow spectrum and which may also be configured with varying types of cones and reflectors via which to adapt or direct the light emissions.

According to certain embodiments, a thermoelectric generator may be utilized to generate electrical potential with a given voltage sufficient to charge a battery or sufficient to power a light source by which to emit light energy. Thus, the emitted light energy may be the result of a burning candle, burning a fat derived bio-fuel, such as a fuel extract produced from the extracted brain matter of a deceased human or pet, or the emitted light energy may be the result of an applied electrical potential transmitted from a battery charged at least in part by the fuel extracted from the brain matter or an applied electrical potential transmitted from a thermoelectric generator powered at least in part by the fuel extracted from the brain matter.

Generally speaking, one type of thermoelectric generator (e.g., TEG), also called a Seebeck generator, is a solid state device that converts heat flux (temperature differences) directly into electrical energy through a phenomenon called the Seebeck effect which is a form of thermoelectric effect. Thermoelectric generators function similarly to heat engines but are less bulky and have no moving parts. However, thermoelectric generators are more expensive and less efficient. In the case of emitting light energy from a fuel source derived from human or pet brain matter, the cost of the thermoelectric generator may be acceptable as it may be reused by the service provider repeatedly without affecting the objective of emitting light energy from brain matter based fuel sources. Similarly, the inefficiency of such devices may also be of lesser concern as the thermoelectric generator provides simplicity through fewer moving parts and again, is sufficient with regard to the objective of emitting light energy from brain matter based fuel sources, especially when low energy demanding LEDs are utilized.

In other embodiments, a more efficient heat engine may be utilized. Generally speaking, a heat engine is a system that converts heat to mechanical energy, which can then be utilized to perform mechanical work, such as turning a rotor within a stator of an electrical motor via which to generate and output electrical potential. The electrical potential may then charge a battery or power a light source from which to emit light energy, thus indirectly linking the emission of the light energy with the burning of the fuel extract derived from the human or pet brain matter.

The heat engine operates by bringing a working substance, such as water, from a higher state temperature to a lower state temperature. A heat source, such as the fuel extracted from the brain matter may thus be used to generate thermal energy. This thermal energy in turn brings the working substance to a higher temperature state. The working substance generates work in the working body of the engine while transferring heat to the colder sink until it reaches a lower temperature state. During this process some of the thermal energy is converted into work by exploiting the properties of the working substance. The working substance can be any system with a non-zero heat capacity, but it usually is a gas or liquid. Ordinary water is a good medium due to its very high specific heat capacity at 4184 J·kg⁻¹K⁻¹. Because of this, water has the ability to absorb, retain, and transfer a large amount of heat energy in proportion to its weight and volume. During the heat transfer process, some heat is lost to the surroundings as inefficiency and thus, is not converted to work. Also, some energy is unusable because of friction and drag. However, like the example before with the thermoelectric generator, the amount of heat energy transferred into the electrical motor will nonetheless be sufficient to generate enough electrical potential by which to power a light source or charge a battery, thus enabling the emission of light energy from the light source, which a known chain of custody for such energy from the emission of light all the way back to the burned fuel-extract which was derived from the human or pet brain matter.

Even more generally, any machine that converts energy to mechanical work may be considered an engine, be it a heat engine or a thermoelectric generator or even an internal combustion engine, all of which may be used to generate electrical potential or mechanical work which is easily transformed into electrical potential through the use of a stator and rotor of an ordinary electrical generator.

One benefit of using a heat engine specifically, however, is that most forms of energy can be easily converted to heat by processes, specifically exothermic reactions, such as burning the brain matter's fuel extract through combustion. Such principals may be exploited to convert energy generated from, for example, nuclear fission, absorption of light or energetic particles, friction, dissipation, and resistance. Since the heat source that supplies thermal energy to the engine can thus be powered by virtually any kind of energy, heat engines cover a wide range of applications.

Notably, heat energy may also be exploited through the use of heat engines for additional matter derived from a deceased human loved one or a deceased pet. Specifically, after extracting the brain matter from a pet or a passed loved one, several jurisdictions in the United States permit the composting of a human body as one type of burial and legal disposal of a deceased body. At the time of this writing, it is believed that composting of human bodies is permissible by law in at least the following jurisdictions: Washington state as the first state (2019), followed by Colorado, Oregon, Vermont, California, and finally New York (2023) as the sixth American jurisdiction to allow human composting.

The composting of organic materials, including a pet or a human body, will generate heat energy, and that heat energy is, once again, exploitable through the use of a heat engine or a thermoelectric generator via which to generate electrical potential to, once again, power a light source directly or indirectly through the intermediate charging of a battery.

Similarly, cremation services are well known and not new, however, what is new is the capture of heat energy from the cremation of a human body or pet, in which the captured heat energy is specifically utilized to power a light source directly or indirectly through the intermediate charging of a battery, thus once again permitting light to be emitted from an energy source derived from a deceased loved one or pet. It is believed that all 50 states and Washington DC allow for the cremation of human bodies.

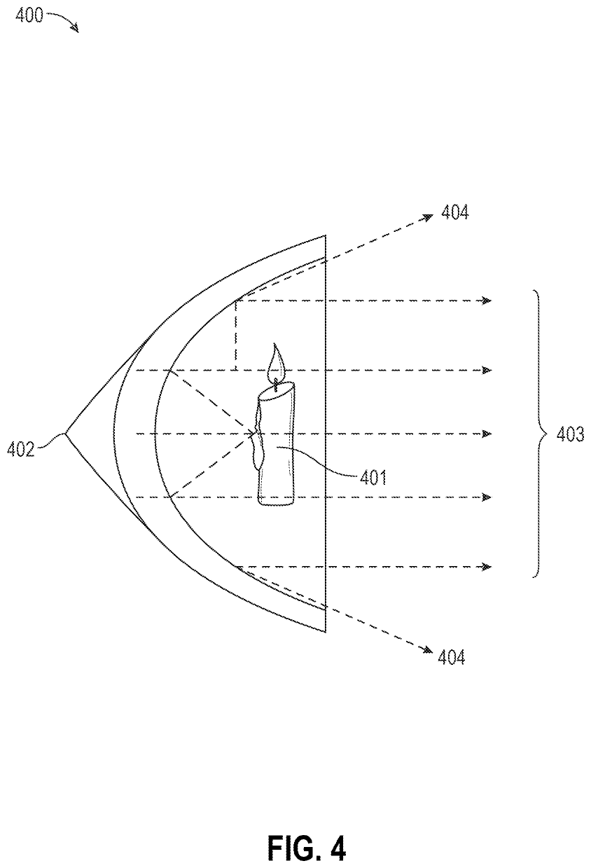

FIG. 4 depicts an exemplary use 400 of a lit fuel-based extract 401 with a parabolic mirror 402 to emit light energy 403-404, in accordance with described embodiments.

According to a particular embodiment, a specially configured parabolic mirror 402 is purposefully utilized which has a circular paraboloid shape, with a cross-section through the optical surface having the shape of a parabola. The properties of parabolic mirror 402 allow for incoming light from lit fuel-based extract 401 or potentially from a wick inserted into a wax of the burning fuel-based extract 401 and which is placed in front of parabolic mirror 402, to reflect light emissions off of the parabolic mirror 402 and thus be directed towards a common focal point, resulting in a beam of light 403 which may be aimed at a target or simply into the sky.

Notably, this is a directly powered light emission as the “energy” is not first converted into electrical energy which then powers light emissions from a light source. Rather, the direct power light emission results from the burning of the ignited fuel-based extract 401 or the burning wick inserted into a wax of the burning fuel-based extract 401 which is placed in front of parabolic mirror 402. In such a way, the parabolic mirror 402 is thus utilized to cast or broadcast a beam of light toward a target or celestial object or towards a desired celestial path with such a beam of light (e.g., the light emission) being powered by the burning fuel-based extract 401.

As shown here, a greater portion of light from the lit fuel-based extract 401 is reflected off of parabolic mirror 402 will thus be reflected into the beam of light emission whereas a much smaller portion of the light is reflected diffusely along the edges of parabolic mirror 402 and will not be concentrated into beam of light 403.

Depending upon the wishes of the user or the deceased, the Life Light service may be preferentially configured in such a way as to facilitate a direct light emission, such as from the burning of extracted candle wax or the lit fuel-based extract 401 (in both instances from the donor brain matter) which is then reflected toward a target or celestial body or a celestial path or alternatively, the indirect light emission through the conversion of the extracted candle wax or the lit fuel-based extract 401 (in both instances from the donor brain matter) which is first converted into electrical energy and either stored or utilized to power a light source, such as an incandescent light, LED light source, or a laser light source, etc.

The particular configuration of the Life Light service is largely preference dependent upon the loved ones or the deceased. Generally speaking, the extraction of the donor brain matter would have already occurred before any such funeral or post-mortem ritual for the deceased. Similarly, the conversion of the donor brain matter into the extracted candle wax or the fuel-based extract 401 which is suitable for ignition is generally contemplated to have occurred prior to any funeral or post-mortem ritual.

However, utilization of the extracted candle wax or the fuel-based extract 401 may be subject to a wide array of preferences. For instance, certain family members may consider a direct powering of the light emissions to be a more “pure” process, as the extracted candle wax or the lit fuel-based extract 401 is converted directly into light energy which is then broadcast. Conversely, indirect powering of the light emission is more convenient as the electrical energy may be extracted ahead of time and then stored within a battery and subsequently utilized at the funeral or post-mortem ritual to power the light emission. In between these two exemplary processes would be the extraction to electrical energy at the time of the funeral or post-mortem ritual, without storage within a battery, which is then consumed by the light source to generate the light emissions.

Note that Life Light makes no representation that any photons emitted from the extracted candle wax or from the fuel-based extract 401 when lit contains any portion of the deceased. However, this is not a requirement of the technical solution. Rather, what is required is to generate light emissions from the donor brain matter in a manner which is suitable to and which honors the deceased in a way which comports with the desires of the surviving loved ones and their chosen funeral or post-mortem ritual concepts. Similarly, Life Light makes no representation that any electrons derived from the conversion of electrical energy from the extracted candle wax or from the fuel-based extract 401 when lit contains any portion of the deceased. However, this is once again not what is required. Rather, what is needed is a process to generate light emissions from the donor brain matter in a manner which is suitable to and which honors the deceased, largely for the comfort of the surviving loved ones.

Thus, while the loved ones of the deceased may speak of the “life essence” being transmitted into the cosmos or the “life energy” being utilized to power a beam of laser light into the infinite unknown of the universe, it is simultaneously understood that the operations described power, for instance, light emissions from the burning of a fuel or the powering of a light source to generate, for instance, the laser light with energy which is derived from a fuel source extracted from the donor brain matter, and yet, there are simpler and more efficient methodologies by which to generate such energies and light emissions. But once again, alternative methodologies are very unlikely to satisfy the emotional needs of the surviving loved ones.

Thus, the admittedly convoluted methodology is performed in furtherance of satisfying the needs and desires of the surviving loved ones of the deceased, notwithstanding the availability of simpler and likely more efficient operational methodologies for transmitting light emissions.

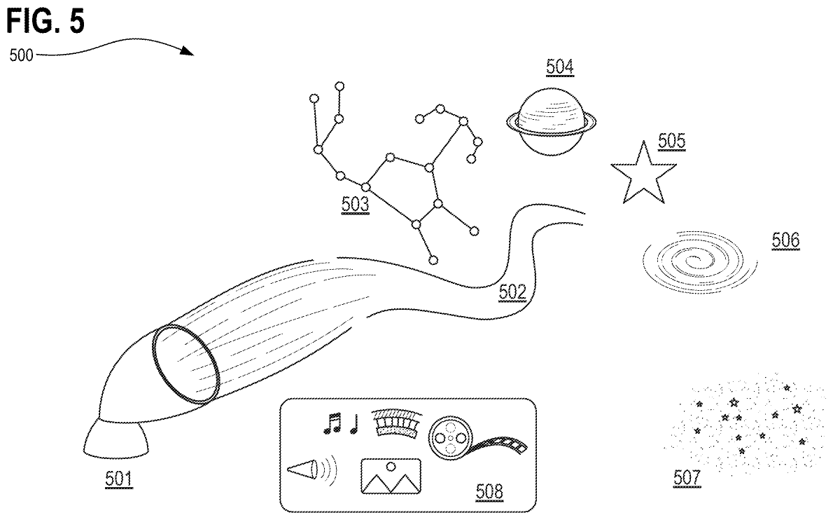

FIG. 5 depicts an exemplary diagram 500 illustrating the projection of emitted light from a light source 501 harnessed with the energy of burning fuel-based extract (e.g., as depicted at element 301 of FIG. 3 and element 401 of FIG. 4) into the cosmos, in accordance with described embodiments.

As shown here, light energy is projected from a light source 501 such as a spot beam, spotlight, diffuse light, candle, laser, LED, incandescent light, etc. Regardless of the particular type of light source utilized, the light is projected upon a spaceflight path 502. This is true regardless of whether the light source is emitting artificial or natural light. According to certain embodiments and subject to the preferences of the user, client, or the deceased, the light energy may be directed toward a celestial object such as a constellation 503, planet 504, star 505, star system/galaxy 507 or deep space 506. According to certain embodiments, the light energy may travel along a pre-determined spaceflight path 502 to reach its intended destination. Spaceflight path 502 may be calculated or determined based on the most efficient route between the light source and the intended destination for the projected light, or a path that travels near or across desired celestial bodies or regions. The course and destination of spaceflight path 502 may include, for example, celestial bodies or regions that had special meaning to the deceased person(s) or animal(s) or were otherwise associated with the deceased person(s) or animal(s) name, interests, etc.

According to certain embodiments, it may take projected light (e.g., emitted photons from the light source) seconds, minutes, hours, days, weeks, months, or years to complete travel through spaceflight path 502. The speed of light, measured as approximately 300 million meters per second in a vacuum such as outer space, is the fastest known way to travel from Earth to other destinations in our solar system and beyond. For example, it takes just over one second for light to travel from the Earth to the Moon (a planet 504), minutes for light to travel from Earth to the Sun (a star 505), hours for light to travel from Earth to farther planets 504 in our solar system, and about 4.3 years for light from Earth to reach Alpha Centauri, the nearest star system 507 to the earth. Thus, the Life Light service allows for light directly or indirectly generated from the brain biomass of loved ones and pets to travel into space towards, for example, a desired celestial body 504-505, constellation 503, or astronomical coordinate. The emitted light may also be directed into open outer space (deep space 506), where it may travel far distances of millions to trillions of miles before hitting a celestial body not visible from Earth.

According to certain embodiments, the projected light in diagram 500 may be supplemented by projecting colors, sounds, music, images, video, or other multimedia effects 508. For instance, at the end of a funeral in which the loved one is buried or as part of a funeral or post-mortem ritual, the emitted light may be transmitted toward its target or emitted into space, supplemented by, for example, spoken word by attendees, prayer, music, additional light effects, and other multi-media content.

According to certain embodiments, the light emission may occur concurrently with the projected light derived from the donor's brain matter, so as to result in a light show, memorial, or ceremony remembering and honoring the deceased whose brain matter has been converted to light energy and projected into the heavens.

It is acknowledged that the amount of energy which is derived from the donor's brain matter may be insufficient to power the duration, intensity, or quantity of light emissions needed or desired for the funeral or post-mortem ritual. Therefore, the supplemental multi-media content is very likely to be powered by alternative and traditional sources. Additionally, at the preference of the Life Light client, user, loved ones, or deceased, the energy derived from the donor's brain matter may be combined with supplemental energy sources and then utilized to power a light source and thus power greater, longer, brighter, more intense, or stronger light emissions. For example, the electrons and voltage from the donor's brain matter may be utilized to increase the charge of a battery and then additionally, another energy source (e.g., such as a standard 110 v electrical socket) may be utilized to further increase the charge of the battery, thus providing for more stored electrical potential via which to power the light source. Thus, it is possible, for instance, to power a stronger laser light which will permit the light emissions to travel farther via a more defined or focused beam. Similarly, the greater electrical storage of a battery charged in such a manner could power a brighter LED light or power an LED or laser light for a longer duration, so as to last throughout the during of a funeral or post-mortem ritual.

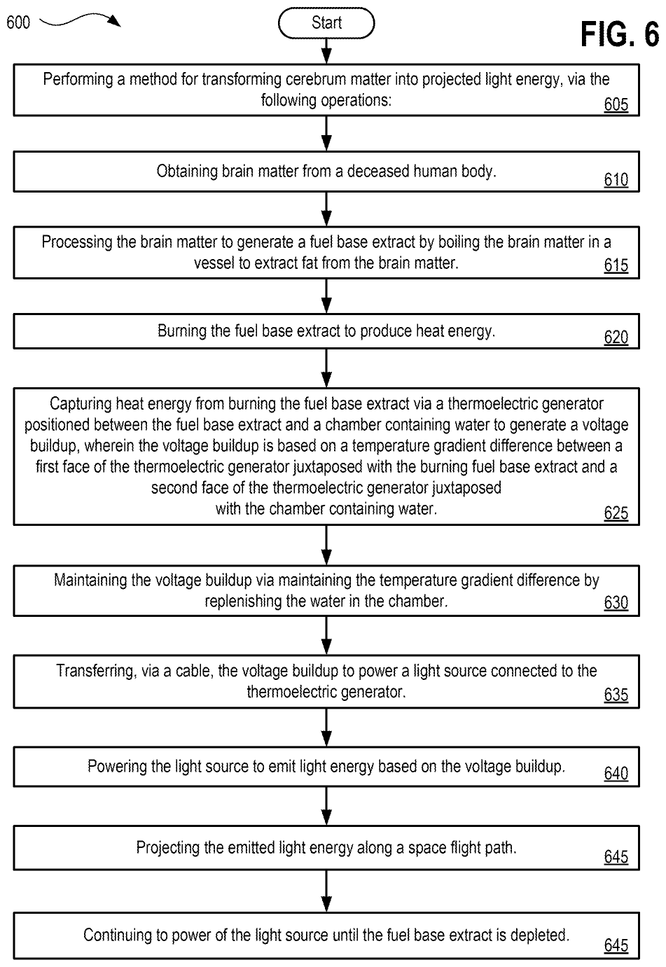

FIG. 6 depicts a flow diagram 600 illustrating a method for implementing cerebrum matter-powered phase transitions for achieving cosmic luminescence, in accordance with disclosed embodiments.

Some of the blocks and/or operations listed below are optional in accordance with certain embodiments. The numbering of the blocks presented is for the sake of clarity and is not intended to prescribe an order of operations in which the various blocks must occur.

With reference to method 600 depicted at FIG. 6 beginning at block 605, there is a method for transforming cerebrum matter into projected light energy by performing the following operations:

At block 610, the method includes obtaining brain matter from a deceased human body.

At block 615, the method includes processing the brain matter to generate a fuel-based extract by boiling the brain matter in a vessel to extract fat from the brain matter.

At block 620, the method includes burning the fuel-based extract to produce heat energy.

At block 625, the method includes capturing heat energy from burning the fuel-based extract via a thermoelectric generator positioned between the fuel-based extract and a chamber containing water to generate a voltage buildup, wherein the voltage buildup is based on a temperature gradient difference between a first face of the thermoelectric generator juxtaposed with the burning fuel-based extract and a second face of the thermoelectric generator juxtaposed with the chamber containing water.

At block 630, the method includes maintaining the voltage buildup via maintaining the temperature gradient difference by replenishing the water in the chamber.

At block 635, the method includes transferring, via a cable, the voltage buildup to power a light source connected to the thermoelectric generator.

At block 640, the method includes powering the light source to emit light energy based on the voltage buildup.

At block 645, the method includes projecting the emitted light energy along a space flight path.

At block 650, the method includes continuing to power the light source until the fuel-based extract is depleted.

According to another embodiment of method 600, processing the brain matter to generate a fuel-based extract is based on one or more of: (i) natural liquefaction of the brain matter, and (ii) hydrothermal liquefaction of the brain matter including high-pressure treatment in a pre-heated reactor followed by cooling.

According to another embodiment of method 600, the fuel-based extract is a combustible material including one or more of: (i) oil, (ii) wax, and (iii) a candle.

According to another embodiment of method 600, burning the fuel-based extract produces one or more of: (i) heat energy, (ii) light energy, and (iii) kinetic energy.

According to another embodiment of method 600, burning the fuel-based extract to produce energy further comprises using the heat energy to power one or more of: (i) a battery, (ii) a laser beam, (iii) a diffuse beam, (iv) a flood beam, (v) flashlight, (vi) LED, (vii) diode, and (viii) a turbine.

According to another embodiment of method 600, the thermoelectric generator is a battery charged by the voltage buildup based on the heat energy from burning the fuel-based extract, wherein the battery is connected to and powers the light source.

According to another embodiment of method 600, the thermoelectric generator is a photovoltaic cell converting the heat energy from burning the fuel-based extract into electrical energy.

According to another embodiment of method 600, the heat energy from burning the fuel-based extract produces hot water and steam via a heat exchanger, wherein the steam powers a turbine, wherein kinetic energy produced by the turbine powers a generator connected to the light source.

According to another embodiment of method 600, the space flight path includes a path from the light source to one or more of: (i) a celestial body, (ii) a constellation, (iii) astronomical coordinates, and (iv) deep space.

According to another embodiment of method 600, the emitted light is one or more of: (i) pulsed, and (ii) continuous light.

According to another embodiment of method 600, the fuel-based extract is a candle fashioned from adipocere, wherein adipocere is naturally generated as fat within the brain matter decomposes through anaerobic bacterial hydrolysis.

According to another embodiment of method 600, a candle serves as the light source, wherein the emitted light is light from the candle when the candle is burned, wherein the emitted light is focused and projected along the space flight path via parabolic mirrors absorbing the emitted light and reflecting them to a single focal point.

According to another embodiment of method 600, one or more of: (i) color effects, (ii) sound effects, (iii) images, (iv) video, and (v) other multimedia are projected with the emitted light.

According to another embodiment of method 600, the brain matter is combined brain matter from one or more of (i) human brains, and (ii) animal brains.

According to another embodiment of method 600, the brain matter is obtained via one or more of: (i) trans-nasal extraction from a deceased body, and (ii) via a registry with a morgue or post-mortem service.

According to another embodiment of method 600, there is a system (“Life Light”) for transforming cerebrum matter into projected light energy including: brain matter obtained from a deceased human body; a fuel-based extract generated by processing the brain matter including boiling the brain matter in a vessel to extract fat from the brain matter; heat energy produced from burning the fuel-based extract; a thermoelectric generator to capture the heat energy produced from burning the fuel-based extract, wherein the thermoelectric generator is position between the burning fuel-based extract and a chamber containing water; a voltage buildup generated based on a temperature gradient difference between a first face of the thermoelectric generator juxtaposed with the burning fuel-based extract and a second face of the thermoelectric generator juxtaposed with the chamber containing water, wherein the voltage buildup is maintained via maintaining the temperature gradient difference by replenishing the water in the chamber; a light source powered based on the voltage buildup to emit light energy, wherein the light source is powered until the fuel-based extract is depleted; a cable to transport the voltage buildup from the thermoelectric generator to the light source; and a space flight path along which to project the emitted light energy.

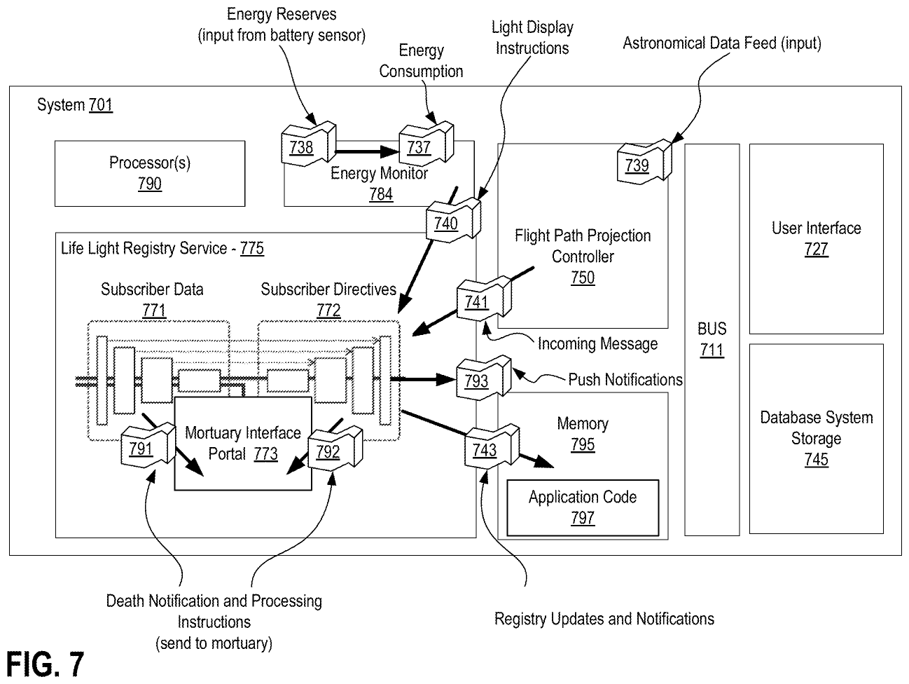

FIG. 7 shows a diagrammatic representation of a system 701 within which embodiments may operate, be installed, integrated, or configured. In accordance with one embodiment, there is a system 701 having at least a processor 790 and a memory 795 therein to execute implementing application code 797. Such a system 701 may communicatively interface with and cooperatively execute with the benefit of remote systems, such as a user device sending instructions and data, a user device to receive as an output from the system 701 including push notifications 793 sent to users and subscribers as well as coordinating messages sent to a morgue or mortuary, such as the death notification and processing instructions at elements 791 and 792. The life light registry services 775 coordinates the collection of subscriber data 771 (such as those persons signing up for a service of a loved one upon death) as well as the various subscriber directives 772 including instructions for how and when and where to process the bodies and brain matter of deceased loved ones and pets. These may be tracked via tracking serial number (see FIG. 1, element 114). The mortuary interface portal 773 permits third-party service providers, such as morgues, mortuaries, cremation services and composting services to coordinate with the life light registry services 775 to ensure timely processing of human and pet remains after death.

The energy monitory 784 receives inputs from the battery or from a thermoelectric generator as to the state of energy reserves 738 as well as energy consumption 737 so as to configure the light display instructions 740 properly and to instruct the flight path projection controller 750 with regard to time sequences and duration, direction, intensity of the light emissions, as well as any associated events, such as sound broadcasts, etc. The flight path projection controller 750 receives inputs in the form of an astronomical data feed 739 via which to ensure appropriate alignment and configuration of the projector with positioning and light emissions into the sky. For instance, certain services offer projection of light emissions into an area of the sky appearing to be empty space, whereas other services offer projection onto planetary bodies or toward a constellation.

According to the depicted embodiment, the system 701, includes a processor 790 and the memory 795 to execute instructions at the system 701. The system 701 as depicted here is specifically customized and configured to systematically control the various inputs such as energy input, subscriber instructions, instructions from mortuary services, etc., with the configured light display and light emissions derived from the brain matter of a pet or loved one.

According to a particular embodiment, there is a specially configured system 701 which is custom configured as a system (“Life Light”) system for transforming cerebrum matter into projected light energy. Such a system includes: collection of brain matter extracted from a deceased human body; a fuel-based extract rendered from fat within the brain matter extracted, with the fuel-based extract being rendered by boiling the brain matter in a vessel to extract the fat from the brain matter's tissues producing the fuel-based extract as a type of bio-fuel; heat energy produced from burning the fuel-based extract; a thermoelectric generator to capture the heat energy produced from burning the fuel-based extract and generate an electrical potential, wherein the thermoelectric generator is positioned between the heat energy produced from burning the fuel-based extract and a thermoelectric material configured to generate an electrical potential, wherein the electrical potential is derived from a temperature gradient difference between a first face of the thermoelectric material and a second face of the thermoelectric material; a cable to transfer the electrical potential from the thermoelectric generator to a light source connected with the thermoelectric generator via the cable; the light source powered using the electrical potential transferred, with the light source being configured to emit light energy; and a projector to project the light energy emitted along a space flight path. According to such an embodiment, the light source is powered to emit the light energy using the electrical potential generated until the fuel-based extract is depleted.

According to another embodiment of the system 701, a user interface 727 communicably interfaces with a user client device remote from the system and communicatively interfaces with the system via a public Internet.

Bus 711 interfaces the various components of the system 701 amongst each other, with any other peripheral(s) of the system 701, and with external components such as external network elements, other machines, client devices, cloud computing services, etc. Communications may further include communicating with external devices via a network interface over a LAN, WAN, or the public Internet.

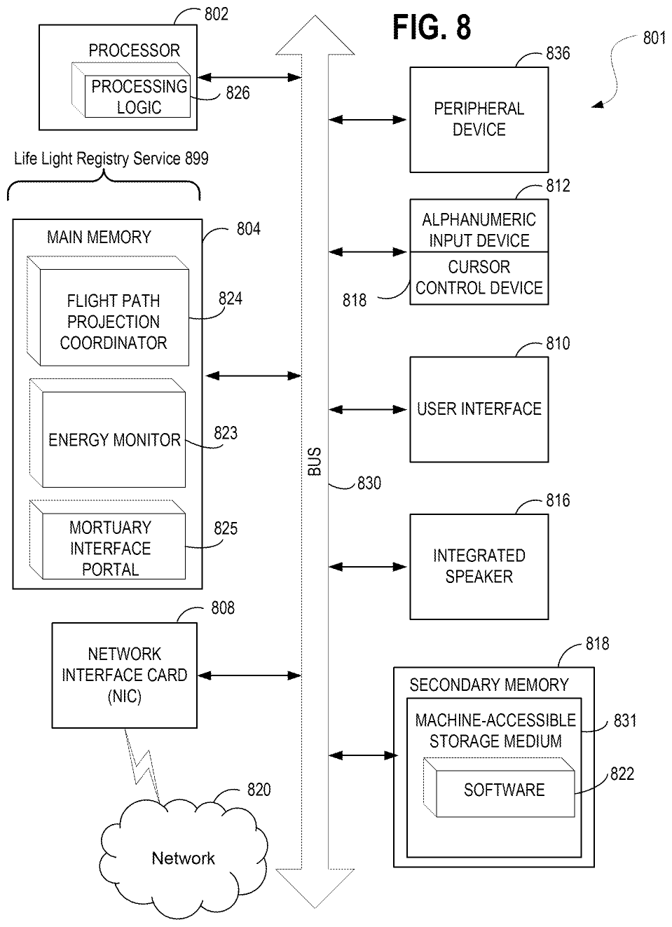

FIG. 8 illustrates a diagrammatic representation of a machine 801 in the exemplary form of a computer system, in accordance with one embodiment, within which a set of instructions, for causing the machine/computer system to perform any one or more of the methodologies discussed herein, may be executed.

In alternative embodiments, the machine may be connected (e.g., networked) to other machines in a Local Area Network (LAN), an intranet, an extranet, or the public Internet. The machine may operate in the capacity of a server or a client machine in a client-server network environment, as a peer machine in a peer-to-peer (or distributed) network environment, as a server or series of servers within an on-demand service environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify and mandate the specifically configured actions to be taken by that machine pursuant to stored instructions. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 801 includes a processor 802, a main memory 804 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 818 (e.g., a persistent storage device including hard disk drives and a persistent database and/or a multi-tenant database implementation), which communicate with each other via a bus 830. Main memory 804 includes instructions for executing the various components of the Life Light Registry Service 899 as described herein, including the flight path projection coordinator 824, the energy monitor 823 which observes and coordinates battery storage, light emissions energy draw duration, intensity, and time, and the mortuary interface portal 825 to coordinate with third party service providers, in support of the methodologies and techniques described herein. Main memory 804 and its sub-elements are further operable in conjunction with processing logic 826 and processor 802 to perform the methodologies discussed herein.

Processor 802 represents one or more specialized and specifically configured processing devices such as a microprocessor, central processing unit, or the like. More particularly, the processor 802 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 802 may also be one or more special-purpose processing devices such as an application-specific integrated circuit (ASIC), a field programmable gate array (FPGA), a digital signal processor (DSP), network processor, or the like. Processor 802 is configured to execute the processing logic 826 for performing the operations and functionality which is discussed herein.

The computer system 801 may further include a network interface card 808. The computer system 801 also may include a user interface 810 (such as a video display unit, a liquid crystal display, etc.), an alphanumeric input device 812 (e.g., a keyboard), a cursor control device 818 (e.g., a mouse), and a signal generation device (e.g., an integrated speaker 816). The computer system 801 may further include peripheral device 836 (e.g., wireless or wired communication devices, memory devices, storage devices, audio processing devices, video processing devices, etc.).

The secondary memory 818 may include a non-transitory machine-readable storage medium or a non-transitory computer readable storage medium or a non-transitory machine-accessible storage medium 831 on which is stored one or more sets of instructions (e.g., software 822) embodying any one or more of the methodologies or functions described herein. The software 822 may also reside, completely or at least partially, within the main memory 804 and/or within the processor 802 during execution thereof by the computer system 801, the main memory 804 and the processor 802 also constituting machine-readable storage media. The software 822 may further be transmitted or received over a network 820 via the network interface card 808.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as are apparent to those skilled in the art. Therefore, the scope of the appended claims is to be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A method for transforming cerebrum matter into projected light energy, comprising:
extracting brain matter from a deceased human body;
rendering fat from the brain matter extracted by boiling the brain matter in a vessel to extract the fat from the brain matter's tissues producing a bio-fuel type fuel-based extract;
burning the fuel-based extract to produce heat energy;
capturing the heat energy from burning the fuel-based extract via a thermoelectric generator positioned between the heat energy produced from burning the fuel-based extract and a thermoelectric material configured to generate an electrical potential, wherein the electrical potential is derived from a temperature gradient difference between a first face of the thermoelectric material and a second face of the thermoelectric material;
transferring, via a cable, the electrical potential to power a light source connected to the thermoelectric generator;
powering the light source to emit light energy using the electrical potential transferred;
projecting the light energy emitted along a space flight path; and
continuing to power the light source using the electrical potential generated until the fuel-based extract is depleted.

2. The method of claim 1:
wherein the thermoelectric generator is a heat engine:
wherein capturing the heat energy from burning the fuel-based extract, comprises:
capturing the heat energy via the heat engine positioned between the fuel-based extract and a chamber containing water to generate an electrical potential via the heat engine, wherein the electrical potential is derived from a temperature gradient difference between a first face of the thermoelectric generator juxtaposed with the burning of the fuel-based extract and a second face of the thermoelectric generator juxtaposed with the chamber containing water; and
maintaining the electrical potential from the thermoelectric generator by maintaining the temperature gradient difference by replenishing the water in the chamber.

3. The method of claim 1, wherein processing the brain matter to generate a fuel-based extract is based on one or more of: (i) natural liquefaction of the brain matter, and (ii) hydrothermal liquefaction of the brain matter including high-pressure treatment in a pre-heated reactor followed by cooling.

4. The method of claim 1:
wherein the fuel-based extract is a combustible material including one or more of: (i) oil, (ii) wax, and (iii) a candle;
wherein burning the fuel-based extract produces one or more of: (i) heat energy, (ii) light energy, and (iii) kinetic energy; and
wherein burning the fuel-based extract to produce the electrical potential further comprises using the heat energy to power one or more of: (i) a battery, (ii) a laser beam, (iii) a diffuse beam, (iv) a flood beam, (v) flashlight, (vi) LED, (vii) diode, and (viii) a turbine.

5. The method of claim 1, wherein the thermoelectric generator is a battery charged by the electrical potential based on the heat energy from burning the fuel-based extract, wherein the battery is connected with the light source and powers the light source.

6. The method of claim 1, wherein the thermoelectric generator is a photovoltaic cell converting the heat energy from burning the fuel-based extract into electrical energy.

7. The method of claim 1, wherein the heat energy from burning the fuel-based extract produces hot water and steam via a heat exchanger, wherein the steam powers a turbine, wherein kinetic energy produced by the turbine powers a generator connected to the light source.

8. The method of claim 1, wherein the space flight path includes a path from the light source to one or more of: (i) a celestial body, (ii) a constellation, (iii) astronomical coordinates, and (iv) deep space.

9. The method of claim 1, wherein the emitted light is one or more of: (i) pulsed, and (ii) continuous light.

10. The method of claim 1, wherein the fuel-based extract is a candle fashioned from adipocere, wherein adipocere is naturally generated as fat within the brain matter decomposes through anaerobic bacterial hydrolysis.

11. The method of claim 1, wherein a candle serves as the light source, wherein the emitted light is light from the candle when the candle is burned, wherein the emitted light is focused and projected along the space flight path via parabolic mirrors absorbing the emitted light and reflecting them to a single focal point.

12. The method of claim 1, wherein one or more of: (i) color effects, (ii) sound effects, (iii) images, (iv) video, and (v) other multimedia are projected with the emitted light.

13. The method of claim 1, wherein the brain matter is combined brain matter from one or more of (i) human brains, and (ii) animal brains.

14. The method of claim 1, wherein the brain matter is obtained via one or more of: (i) trans-nasal extraction from a deceased body, and (ii) via a registry with a morgue or post-mortem service.

15. A system (“Life Light”) for transforming cerebrum matter into projected light energy, the system comprising:
brain matter extracted from a deceased human body;
a fuel-based extract rendered from fat within the brain matter extracted, with the fuel-based extract being rendered by boiling the brain matter in a vessel to extract the fat from the brain matter's tissues producing the fuel-based extract as a type of bio-fuel;
heat energy produced from burning the fuel-based extract;
a thermoelectric generator to capture the heat energy produced from burning the fuel-based extract and generate an electrical potential, wherein the thermoelectric generator is positioned between the heat energy produced from burning the fuel-based extract and a thermoelectric material configured to generate an electrical potential, wherein the electrical potential is derived from a temperature gradient difference between a first face of the thermoelectric material and a second face of the thermoelectric material;
a cable to transfer the electrical potential from the thermoelectric generator to a light source connected with the thermoelectric generator via the cable;
the light source powered using the electrical potential transferred, wherein the light source is configured to emit light energy;
a projector to project the light energy emitted along a space flight path; and
wherein the light source is powered to emit the light energy using the electrical potential generated until the fuel-based extract is depleted.

16. The system of claim 15, wherein the fuel-based extract is a candle fashioned from adipocere, wherein adipocere is naturally generated as fat within the brain matter decomposes through anaerobic bacterial hydrolysis, wherein the candle serves as the light source, wherein the emitted light is light from the candle when the candle is burned, wherein the emitted light is focused and projected along the space flight path via parabolic mirrors absorbing the emitted light and reflecting them to a single focal point.

17. The system of claim 15, wherein the fuel-based extract is generated based on one or more of: (i) natural liquefaction of the brain matter, and (ii) hydrothermal liquefaction of the brain matter including high-pressure treatment in a pre-heated reactor followed by cooling.

18. The system of claim 15, wherein the heat energy produced from burning the fuel-based extract is used to power one or more of: (i) a battery, (ii) a laser beam, (iii) a diffuse beam, (iv) a flood beam, (v) flashlight, (vi) LED, (vii) diode, and (viii) a turbine, wherein the thermoelectric generator is one or more of: (i) a battery charged by the voltage buildup based on the heat energy from burning the fuel-based extract, wherein the battery is connected to and powers the light source, and (ii) a photovoltaic cell converting the heat energy from burning the fuel-based extract into electrical energy.

19. The system of claim 15, wherein the heat energy from burning the fuel-based extract produces hot water and steam via a heat exchanger, wherein the steam powers a turbine, wherein kinetic energy produced by the turbine powers a generator connected to the light source.

20. The system of claim 15, wherein the space flight path includes a path from the light source to one or more of: (i) a celestial body, (ii) a constellation, (iii) astronomical coordinates, and (iv) deep space.
